(19) United States
(12) Patent Application Publication
(10) Pub. No.: US 2026/0067059 A1
(43) Pub. Date: Mar. 5, 2026

(54) SHARED DIGITAL COMMUNICATIONS BUS SUITABLE FOR AUTOMOTIVE APPLICATIONS

(71) Applicant: SEMICONDUCTOR COMPONENTS INDUSTRIES, LLC, Scottsdale, AZ (US)

(72) Inventors: Jean-Paul Anna Joseph EGGERMONT, Pellaines (BE); Johannes VORENHOLT, Leek (NL)

(73) Assignee: SEMICONDUCTOR COMPONENTS INDUSTRIES, LLC, Scottsdale, AZ (US)

(21) Appl. No.: 18/817,174

(22) Filed: Aug. 27, 2024

(51) Int. Cl. H04L 7/08; H04L 7/04; H04L 12/40

(52) U.S. Cl. CPC H04L 7/08; H04L 7/044; H04L 12/40013; H04L 12/40032; H04L 2012/40215; H04L 2012/40273

(57) ABSTRACT

An illustrative network includes: n nodes coupled to a signal conductor, n being an integer greater than one; and a bus controller configured to transmit periodic pulses via the signal conductor, each pulse initiating a data transmission slot. Each of the multiple nodes has a node ID and is configured to determine which of the data transmission slots correspond to that node ID by: driving the signal conductor with a pulse representing a resynchronization request if n-1 consecutive data transmission slots are empty; and upon driving or detecting a pulse representing a resynchronization request, tracking a data transmission slot count that treats a first data transmission slot after a resynchronization request as the first data transmission slot in a series of frames each having n data transmission slots, each data transmission slot in the frame having a slot count that matches a respective one of the node IDs.

### TECHNICAL FIELD

The present disclosure relates to network communications systems and methods, particularly to such systems and methods providing automatic coordination among multiple nodes on a controller-synchronized time division multiple access bus.

### BACKGROUND

Modern automobiles are equipped with an impressive number and variety of sensors, including “high speed” sensors employing a resolver with an analog interface for in phase and quadrature phase output signals. To provide protection against electromagnetic interference and emissions, each of the output signals is typically conveyed as a differential signal over a twisted wire pair, requiring multiple twisted wire pairs and relatively costly filters to maintain electromagnetic compatibility.

In U.S. Pat. No. 11,985,219 “Digital communications bus suitable for automotive applications”, the present inventors proposed a digital interface for such sensors to provide the necessary data rates with robust operation and reduced implementation cost. The proposed interface performs well but relies on a dedicated point-to-point bus from the controller to the sensor. Adapting the proposed solution to enable bus sharing would enable further reduction of wiring costs so long as it can be achieved without loss of performance, loss of reliability, or an increase in interface manufacturing cost.

### SUMMARY

Accordingly, there are disclosed herein a shared digital communications bus suitable for automotive applications, along with bus controllers and sensors that use the bus and its associated communication methods. An illustrative network includes: n nodes coupled to a shared signal conductor, n being an integer greater than one; and a bus controller configured to transmit periodic pulses via the shared signal conductor, each pulse initiating a data transmission slot. Each of the multiple nodes has a node ID and is configured to determine which of the data transmission slots correspond to that node ID by: driving the shared signal conductor with a pulse representing a resynchronization request if n-1 consecutive data transmission slots are empty; and upon driving or detecting a pulse representing a resynchronization request, tracking a data transmission slot count that treats a first data transmission slot after a resynchronization request as the first data transmission slot in a series of frames each having n data transmission slots, each data transmission slot in the frame having a slot count that matches a respective one of the node IDs.

An illustrative sensor includes: a bus interface coupled to a shared signal conductor to detect periodic pulses from a bus controller, each pulse initiating a data transmission slot; and a controller having a node ID and configured to determine which of the data transmission slots correspond to that node ID by: driving the shared signal conductor with a pulse representing a resynchronization request if n-1 consecutive data transmission slots are empty, n being a total number of sensors connected to the shared signal conductor; and upon driving or detecting a pulse representing a resynchronization request, tracking a data transmission slot count that treats a first data transmission slot after the resynchronization request as the first data transmission slot in a series of frames each having n data transmission slots, each data transmission slot in the frame having a slot count that matches a respective node ID.

An illustrative digital communication method includes: detecting periodic pulses on a shared signal conductor, each pulse initiating a data transmission slot; and determining which of the data transmission slots correspond to a local node ID by: driving the shared signal conductor with a pulse representing a resynchronization request if n-1 consecutive data transmission slots are empty, n being a total number of sensors connected to the shared signal conductor; and upon driving or detecting a pulse representing a resynchronization request, tracking a data transmission slot count that treats a first data transmission slot after the resynchronization request as the first data transmission slot in a series of frames each having n data transmission slots, each data transmission slot in the frame having a slot count that matches a respective node ID.

Each of the foregoing may be employed individually or conjointly, and they may further employ one or more of the following optional features in any suitable combination: 1. each of the multiple nodes is configured to set the data transmission slot count based on a node ID included in a data transmission from another node. 2. each data transmission slot is sized to accommodate multiple bytes. 3. the pulse representing a resynchronization request has a position corresponding to a second of the multiple bytes. 4. each node is configured to treat a data transmission slot as empty if that data transmission slot lacks a first byte and lacks a pulse representing a resynchronization request. 5. the shared signal conductor is one of a pair of differential signal conductors. 6. each of the n nodes comprises a sensor. 7. each of the n nodes captures a measurement at a synchronized time relative to a beginning of each frame. 8. each of the n nodes aligns a bus clock signal with the periodic transmit pulses. 9. the method includes generating a local clock signal, aligning the local clock signal with the periodic pulses, and sending digital data during the data transmission slots corresponding to the local node ID. 10. said determining includes resetting the data transmission slot count upon detecting that one of the periodic pulses is elongated.

### BRIEF DESCRIPTION OF THE DRAWINGS

FIG. 1 is a block diagram of an illustrative controller area network.

FIG. 2. is a circuit schematic of an illustrative digital communications bus.

FIG. 3 is a timing graph showing various illustrative signal waveforms in the system.

FIG. 4 is a graph of clock synchronization phases.

FIG. 5 is a flow diagram of an illustrative data communication method.

FIG. 6 is a timing graph for a shared bus startup example.

FIG. 7 is a timing graph comparing various startup scenarios for a given sensor.

FIG. 8 is a timing graph for another shared bus startup example.

### DETAILED DESCRIPTION

The following description and accompanying drawings are provided for explanatory purposes, not to limit the disclosure. In other words, they provide the foundation for one of ordinary skill in the art to recognize and understand all modifications, equivalents, and alternatives falling within the scope of the claims.

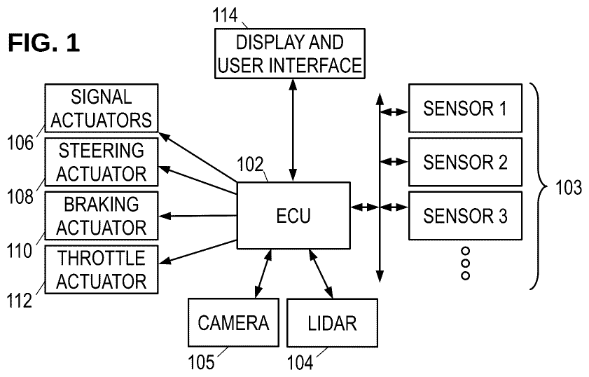

FIG. 1 shows an illustrative controller area network (CAN) such as might be found in an automotive context. An electronic control unit (ECU) 102 is coupled to various sensors 103 by a shared bus, and to a LIDAR (light detection and ranging) unit 104 and a camera 105 via point-to-point links, in a central computing architecture. Various distributed computing architectures, such as tree, ring, mesh, and daisy chain, may also be suitable. To provide automated driver assistance, the ECU 102 may further connect to a set of actuators such as a turn-signal actuator 106, a steering actuator 108, a braking actuator 110, and throttle actuator 112. ECU 102 may be further coupled to an interactive interface 114 to accept user input and provide a display of the various measurements and system status. Using the interface, sensors, and actuators, ECU 102 may provide automated parking, assisted parking, lane-change assistance, obstacle and blind-spot detection, and other desirable features.

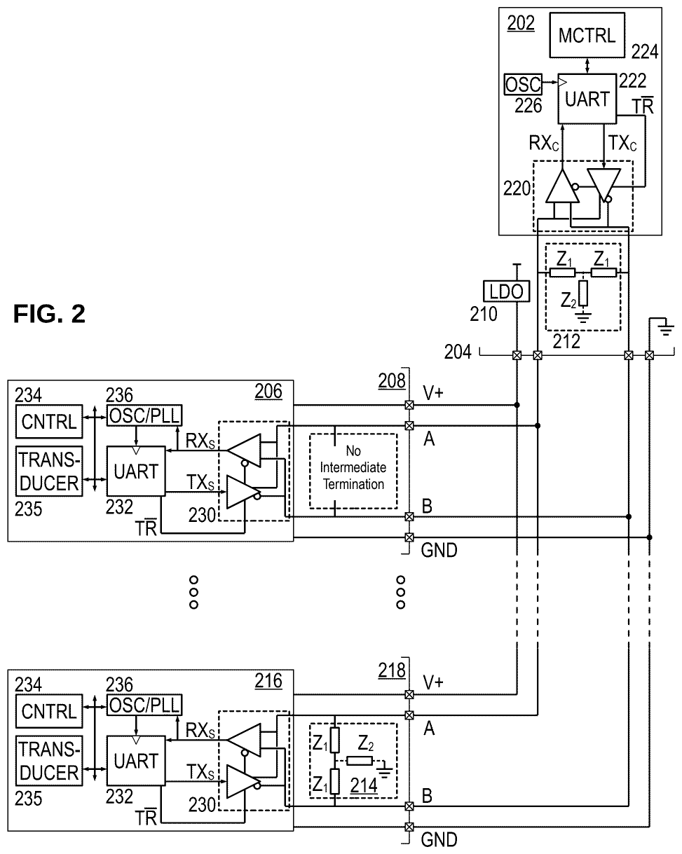

FIG. 2 is a schematic of an illustrative data bus having a bus controller 202 (such as ECU 102) on a first printed circuit board (PCB) 204 coupled to multiple sensors 206, 216 on respective PCBs 208, 218 or other suitable sensor circuitry substrates. The first PCB 204 includes a low drop out (LDO) voltage regulator 210 and a ground connection to supply power to the sensor PCBs 208, 218 via respective conductors V+, GND. A shared pair of differential signal conductors A, B transports a downlink signal from the bus controller 202 to the sensors 206, 216 and an uplink signal from the sensors to the bus controller.

The first and last PCBs may include termination circuits 212, 214 to provide impedance matching and/or electromagnetic compatibility by attenuating higher frequencies. The termination circuits are shown here as two equal impedances Z1 connected in series between conductors A and B, with an optional impedance Z2 coupled between the intermediate node and ground. The impedances Z1, Z2 can be chosen to provide the desired lowpass cutoff frequency.

The illustrated bus controller 202 includes a transceiver 220 for alternately sending a downlink signal TX_{C} and receiving an uplink signal RX_{C}. A universal asynchronous receiver/transmitter (UART) module 222 formulates the downlink signal to carry synchronization pulses from microcontroller (MCTRL) 224 and decodes the uplink signal to provide responses and measurement data from sensors 206, 216 to the microcontroller 224. Optionally (e.g., for RS485-type transceivers), the UART module 222 provides a T/R signal to the transceiver 220 to toggle between transmit and receive modes. CAN-compliant transceivers do not require a signal to transition between transmit and receive modes. An oscillator 226 provides a clock signal to the UART module 222. The UART's operations are performed in accordance with the clock signal, and hence the clock signal determines the timing of symbol transitions in the downlink signal.

Each of the illustrated sensors 206, 216 similarly includes a transceiver 230 for alternately receiving the downlink signal RX_{S} and sending the uplink signal TX_{S}, optionally operating in response to a T/R signal from a UART module 232. As discussed further below, controller 234 receives the synchronization pulses that define data transmission slots for sensor measurement data and provides measurements from transducer circuitry 235 for the UART 232 to convert into upload messages. An oscillator 236 provides a clock signal for use by the UART 232. As described further below, the clock signal generated by oscillator 236 may be aligned with periodic synchronization pulses from the bus controller 202, enabling the UART 232 to generate uplink messages with symbols synchronized to the clock signal generated by oscillator 226.

Each of the multiple sensors 206, 216 is given a node ID in the range 0 to n-1, where n is the number of sensors sharing the differential signal pair A/B. The node ID may be assigned by configuring jumpers on the sensor PCBs 208, 218, hardwiring external pins of the packaged sensors 206, 216, firmware programming, or any other suitable technique of ensuring each sensor has a distinct node ID in the given range.

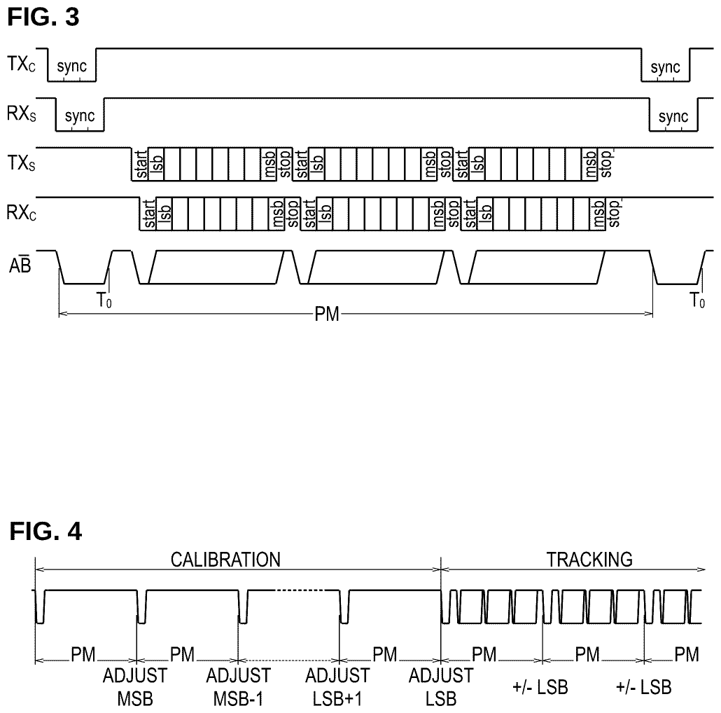

FIG. 3 shows an illustrative timing relationship between the various signal waveforms that may be present on the digital communications bus. After a power-on or reset, the bus controller sends periodic synchronization pulses as shown in waveform TX_{C}. These pulses serve to define data transmission slots and may further serve as a timing reference signal for the sensors. The illustrated pulses are three bit intervals wide, but this is not a requirement. As described in more detail below, the initial pulse sent by the bus controller may optionally be elongated (e.g., greater than five bit intervals wide) to signal a bus reset and pause all sensor transmissions, forcing a restart of the coordination process for sensor transmissions. The bus controller may also later use the elongated synchronization pulse as a mechanism for forcing a bus reset, e.g., upon detecting excessive noise or some other indication of a bus collision (transmissions from different sensors in a given data transmission slot). This reset mechanism may advantageously avoid disrupting the sensors'clock synchronizations, facilitating a fast return to normal bus operation after an error. More severe bus communication failures may require a power cycling (hard restart) of the bus nodes, which may be expected to lengthen the delay before the bus returns to normal operations.

Waveform RX_{S} shows the periodic synchronization pulses received at a given sensor with a slight delay due to propagation time through the conductors and interface electronics. The sensor responds with an uplink waveform TX_{S}, shown here as a template for three UART-standard bytes each having a single start bit preceding the least significant bit and a stop bit following the most significant bit. Additional stop bits may be preferred in some systems, and in other systems it may be preferred to skip the stop bits. Other message formats would also be suitable, e.g., a greater or lesser number of bytes, different bit ordering, and/or different word lengths between start and stop bits. Waveform RX_{C} shows the uplink waveform with a delay to represent the propagation time from the sensor to the bus controller.

The last curve of FIG. 3 shows the differential voltage between the signal conductors A, B. The sensor may use the interval between leading edges of the synchronization pulses as the synchronization period measurement (PM) from which the bit period (or more generally, “symbol period”) is derived, and may use the trailing edges of the synchronization pulses as the zero-phase alignment for the transmit symbol clock.

The synchronization and alignment process may be performed across multiple synchronization pulse cycles as shown in FIG. 4. An initial calibration period begins after power-on or when the sensor is reset. After detecting the synchronization pulses, the sensor begins acquiring period measurements between the leading edges of the pulses. In one contemplated embodiment, the sensor uses a phase lock loop (PLL) having local voltage-controlled oscillator (VCO) coupled to a counter or “frequency divider”. The control voltage is set to a default mid-range value and the most significant bit of an adjustment value is set. If the next synchronization pulse arrives before the counter elapses, the control voltage is increased by the adjustment value to increase the local oscillator frequency. Conversely, if the counter elapses before the next synchronization pulse arrives, the control voltage is decreased by the adjustment value to decrease the local oscillator frequency. The adjustment value is then cut in half, so that only its second-most significant bit is asserted. The process is repeated until only the least significant bit of the adjustment value is asserted.

Once the smallest adjustment value is reached and applied, the sensor may transition from calibration mode to tracking mode. During the tracking mode, the sensor determines which of the data transmission slots correspond to that sensor's node ID and uses those slots to send measurement data to the bus controller. The sensor continues to monitor the period between synchronization pulses and adds or subtracts the minimum adjustment value from the control voltage after each period measurement. In some implementations, the sensor may detect when the adjustments regularly alternate in sign and may then apply an error filter or may otherwise increase the number of synchronization pulses used for each adaptation of the control voltage.

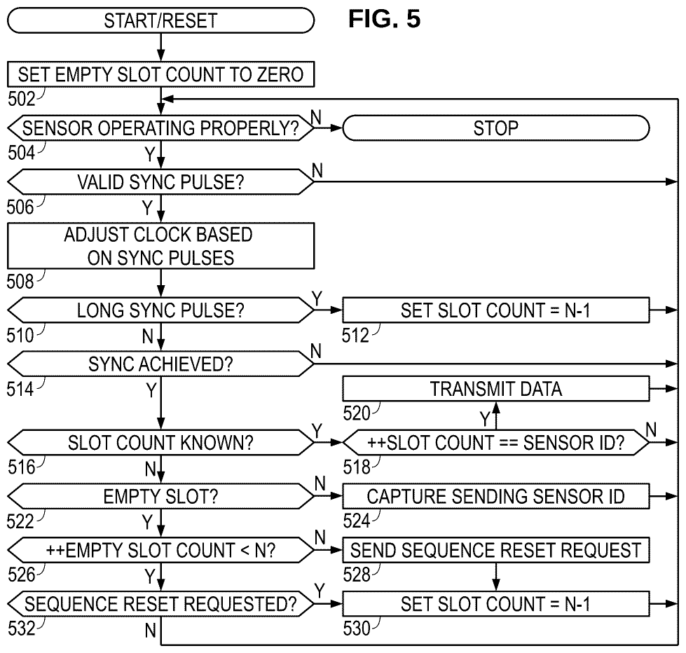

FIG. 5 is a flow diagram of an illustrative data communication method that may be implemented by each sensor device. In block 502, the sensor initializes an empty slot count variable. In block 504, determines whether it is operating properly, and if not, ceases any transmissions and halts until the next power-on or hard reset.

Otherwise, the sensor monitors the bus in block 506 for a sync pulse from the bus controller. If a sync pulse is detected in block 506, the sensor adjusts its local clock to based on the sync pulse in block 508. One suitable clock calibration technique is set forth in U.S. Pat. No. 11,985,219 “Digital communications bus suitable for automotive applications”. If in block 510, the sensor determines the sync pulse is elongated, the sensor sets the slot count to n-1 in block 512, where n is the number of sensors. From block 512, the control flow returns to block 504. This path enables the bus controller to resynchronize the bus as needed for fast recovery from a bus error such as, e.g., a bus collision.

If in block 510 the sensor determines the pulse is not elongated, the sensor determines in block 514 whether the local clock is adequately synchronized with the sync pulses, and if not, control returns to block 504. This path ensures the sensor achieves bus clock synchronization before transmitting anything.

Otherwise, in block 516, the sensor determines whether the sensor is tracking the slot count. If so, in block 518 the sensor increments the slot count (modulo n) to obtain the slot count for the current data transmission slot. If the slot count matches the sensor's node ID, the sensor uses the current data transmission slot to send digital measurement data to the controller in block 520 before returning to block 504. The data preferably includes a field for the node ID of the sensor sending the measurement data. If the slot count does not match the sensor's node ID, the sensor returns directly to block 504.

If in block 516, the sensor determines the slot count is unknown, it checks in block 522 whether the current data transmission slot is empty. If not empty, i.e., if another sensor is using the data transmission slot, the sensor in block 524 monitors the data transmission to capture the node ID of the sensor using the slot, setting the slot count equal to the captured node ID before returning to block 504. If the current slot is empty as would be indicated by the absence of a first data byte, in block 526 the sensor increments the empty slot counter and compares the empty slot count to the number of sensors n. The empty slot counter indicates the number of consecutive empty slots, and having n consecutive empty slots indicates that none of the sensors has started using its data transmission slots. The first sensor to detect n consecutive empty slots sends a signal representing a resynchronization request in block 528. The request signal may be a long pulse extending for the full duration of a data byte (including start and stop bits, if any). In some implementations, the request signal is positioned to occupy the same space that would be occupied by a second byte if a sensor were using the slot for data transmission to the bus controller. In block 530, each of the sensors respond to the request signal by setting their slot count to n-1, and increment their slot counts modulo n, thereby treating the first data transmission slot after a resynchronization request as the first data transmission slot in a series of frames each having n data transmission slots, each data transmission slot in the frame having a slot count that matches a respective one of the node IDs.

If the empty slot count has not yet reached n, in block 532 the sensor monitors the data transmission slot for a signal representing a resynchronization request. If no request is detected, the sensor returns to block 504. Otherwise, in block 530, the sensor initializes the slot counter before returning to block 502.

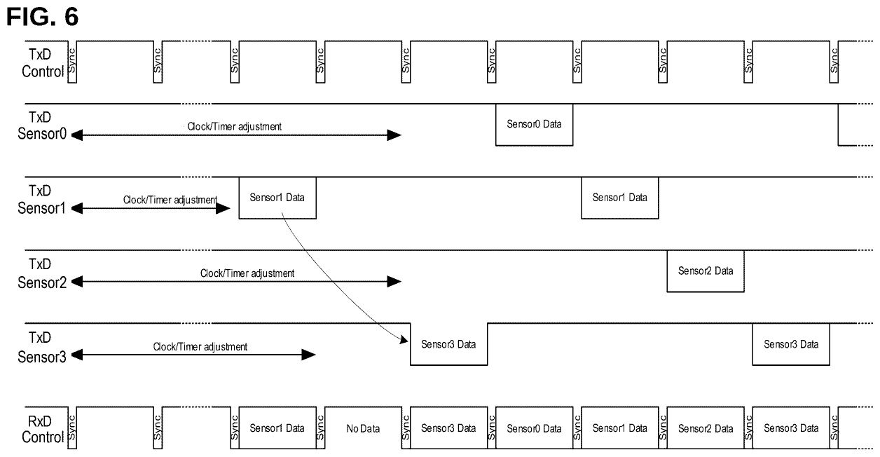

FIG. 6 shows an example of a shared bus startup process employing the disclosed automatic synchronization technique. The top graph shows the TX_{C} signal (labeled TxD Control) with a series of synchronization pulses from the bus controller. The next four graphs show the TX_{S} signals for four sensors (labeled TxD Sensor0, TxD Sensor1, TxD Sensor2, and TxD Sensor3), each including a corresponding sensor startup and calibration time that varies between sensors. In this example, Sensor1 completes startup and calibration first and is the first to send a resynchronization request (not shown) and to begin transmitting data (Sensor1 Data). Sensor3 completes its startup next and is able to set its slot counter based on the timing of the Sensor1 Data. Sensor3 begins transmitting data in its data transmission slots. Sensor0 and Sensor2 complete their startups last and are able to set their slot counters based on the next data transmission which in this example is Sensor3 Data.

At this point, each of the sensors has determined its associated data transmission slots and employs their associated slots to provide measurement data to the bus controller. The last graph in FIG. 6 shows the RX_{C} signal (labeled RxD Control) having the combined measurement data from each of the sensors on the shared bus. We note that the bus controller was never required to use the bus for any downlink commands or data other than the synchronization pulses that define the data transmission slots. The sensors achieved coordinated data transmission automatically.

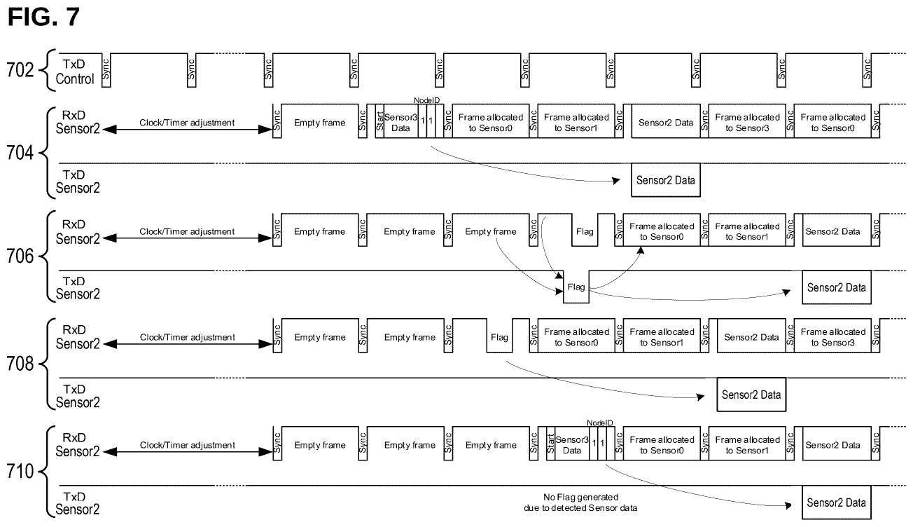

FIG. 7 is a timing graph comparing various startup scenarios for a given sensor, in this case Sensor2. As with the previous example, these scenarios assume the presence of four sensors on the shared bus. Graph 702 shows the TX_{C} signal for each of the four scenarios. Each of the four scenarios 704-710, has a top graph showing the RX_{S} signal for Sensor2 and a bottom graph showing the TX_{S} signal for Sensor2.

In the first scenario 704, the first data transmission slot after Sensor2 completes calibration is empty, and the next data transmission slot contains Sensor3 Data (including a Node ID field identifying Sensor3 as the transmitter). Sensor2 captures the Node ID and initializes its slot counter accordingly, enabling it to transmit Sensor2 Data in the correct data transmission slot.

In the second scenario 706, Sensor2 observes four empty data transmission slots after it completes calibration. In the fourth data transmission slot, Sensor2 sends a resynchronization request pulse (“Flag”) and initializes its slot counter, enabling it to transmit Sensor2 Data in the correct data transmission slot. It is possible for multiple sensors to coincidentally transmit a resynchronization request pulse at almost the same time. Because the same signal is being sent by the multiple sensors, no harm is caused by such collisions.

In the third scenario 708, Sensor2 observes a resynchronization request pulse from one of the other sensors in the third data transmission slot. Sensor2 responsively initializes its slot counter, enabling it to send Sensor2 Data in the correct data transmission slot.

In the fourth scenario 710, Sensor2 observes three empty data transmission slots and, in the fourth data transmission slot it would have sent a resynchronization request pulse except that it first detects Sensor3 Data. Sensor2 captures the Node ID and initializes its slot counter accordingly, enabling it to transmit Sensor2 Data in the correct data transmission slot.

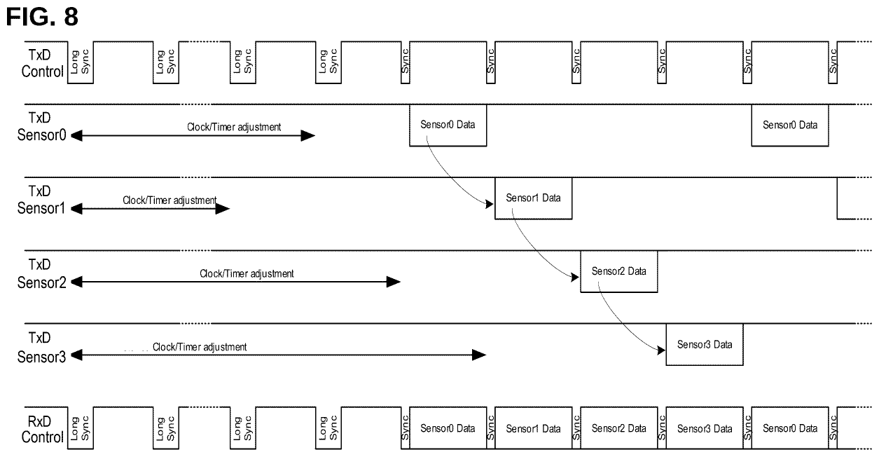

To better illustrate the controller's ability to pause and reset the sensor transmissions, FIG. 8 shows another example of a shared bus startup process. The top graph shows the TX_{C} signal (labeled TxD Control) with a series of long synchronization pulses from the bus controller. The next four graphs show the TX_{S} signals for four sensors (labeled TxD Sensor0, TxD Sensor1, TxD Sensor2, and TxD Sensor3), each including a corresponding sensor startup and calibration time that varies between sensors. In this example, Sensor1 completes startup and calibration first and can detect the long synchronization pulses from the controller, causing Sensor1 to keep resetting its slot count without sending any sensor data. Sensor0 also completes startup and calibration while the controller is still sending long synchronization pulses and similarly resets its slot count and refrains from sending sensor data until a short sync pulse is received.

Sensor2 and Sensor 3 conclude their startup and calibration after the controller begins sending short synchronization pulses. These sensors are able to set their slot counters based on the timing of the data transmissions from Sensor0 and Sensor1. Sensor2 and Sensor3 begin transmitting sensor data in their respective data transmission slots. At this point, each of the sensors has determined its associated data transmission slots and employs their associated slots to provide measurement data to the bus controller. The last graph in FIG. 8 shows the RX_{C} signal (labeled RxD Control) having the combined measurement data from each of the sensors on the shared bus.

The clock synchronization achieved between the sensors and bus controller is expected to enable much higher data transfer rates including rates above about 8 Mbps on buses that otherwise conform to the CAN-FD automotive bus standard. In contrast with other bus types, such as buses where a bus controller employs a question & answer protocol to selectively retrieve data from multiple addressable sensor devices, the disclosed synchronized interface clock configuration enables multiple sensors using a minimal yet robust signaling protocol to continuously supply measurement information to the controller without limiting the manner in which the sensor acquires the measurement information.

In systems where synchronous measurements are desired, the sensors may be configured to coordinate their measurement acquisition relative to one of the data transmission slots. As one example, the sensors may each be configured to perform measurement acquisition immediately prior to the synchronization pulse for the data transmission slot allocated to Sensor0. Though the sensor measurements are communicated in sequence, the associated measurement times would be simultaneous or at least concurrent across all sensors.

In systems requiring high timing precision, the sensor data may transmit measurement timestamps with the measurement data. In some implementations, the sensor measurement clocks may be synchronized to the pulses from the bus controller and the timestamp may be conveyed as a timing offset from a given data transmission slot in each data frame of n allocated data transmission slots.

Those of ordinary skill in the art having the benefit of the foregoing description and accompanying drawings will recognize equivalents, variations, and alternative embodiments that fall within the scope of this disclosure and the attached claims. For example, the disclosed controller, sensors, and bus, need not be confined to an automotive context but rather lend themselves to other contexts where networks are employed. The bus nodes need not be sensors but rather may be a network node providing digital communications to a bus controller for any purpose and in a wide range of contexts including commercial buildings, industrial facilities, medical facilities, surveillance networks, telecommunications networks, marine vessels, aircraft, spacecraft, and monitoring networks for bridges and other structures. Though the operations shown and described in FIG. 5 are treated as being sequential for explanatory purposes, in practice the operations may be reordered, and the method may be carried out by multiple integrated circuit components operating concurrently. The sequential discussion is not meant to be limiting.

What is claimed is:

1. A network that comprises:
n nodes coupled to a shared signal conductor, n being an integer greater than one; and
a bus controller configured to transmit periodic pulses via the shared signal conductor, each pulse initiating a data transmission slot,
each of the n nodes having a node ID and being configured to determine which of the data transmission slots correspond to that node ID, said determining including:
driving the shared signal conductor with a pulse representing a resynchronization request if n-1 consecutive data transmission slots are empty; and
upon driving or detecting a pulse representing a resynchronization request, tracking a data transmission slot count that treats a first data transmission slot after a resynchronization request as the first data transmission slot in a series of frames each having n data transmission slots, each data transmission slot in the frame having a slot count that matches a respective one of the node IDs.

2. The network of claim 1, wherein as part of said determining, each of the multiple nodes is configured to set the data transmission slot count based on a node ID included in a data transmission from another node.

3. The network of claim 1, wherein each data transmission slot is sized to accommodate multiple bytes, and wherein the pulse representing a resynchronization request has a position corresponding to a second of the multiple bytes.

4. The network of claim 3, wherein each node is configured to treat a data transmission slot as empty if that data transmission slot lacks a first byte.

5. The network of claim 1, wherein the shared signal conductor is one of a pair of differential signal conductors.

6. The network of claim 1, wherein each of the n nodes comprises a sensor.

7. The network of claim 6, wherein each of the n nodes captures a measurement at a synchronized time relative to a beginning of a frame.

8. The network of claim 1, wherein each of the n nodes aligns a bus clock signal with the periodic transmit pulses.

9. A sensor that comprises:
a bus interface coupled to a shared signal conductor to detect periodic pulses from a bus controller, each pulse initiating a data transmission slot; and
a controller having a node ID and configured to determine which of the data transmission slots correspond to that node ID, said determining including:
driving the shared signal conductor with a pulse representing a resynchronization request if n-1 consecutive data transmission slots are empty, n being a total number of sensors connected to the shared signal conductor; and
upon driving or detecting a pulse representing a resynchronization request, tracking a data transmission slot count that treats a first data transmission slot after the resynchronization request as the first data transmission slot in a series of frames each having n data transmission slots, each data transmission slot in the frame having a slot count that matches a respective node ID.

10. The sensor of claim 9, wherein as part of said determining, the controller is configured to set the data transmission slot count based on a node ID included in a data transmission from another sensor.

11. The sensor of claim 9, wherein each data transmission slot is sized to accommodate multiple bytes, and wherein the pulse representing a resynchronization request has a position corresponding to a second of the multiple bytes.

12. The sensor of claim 11, wherein each node is configured to treat a data transmission slot as empty if that data transmission slot lacks a first byte.

13. The sensor of claim 9, wherein the shared signal conductor is one of a pair of differential signal conductors.

14. The sensor of claim 9, wherein the controller is configured to align a bus clock signal with the periodic pulses.

15. The sensor of claim 9, wherein said determining further includes:
resetting the data transmission slot count upon detecting that one of the periodic pulses from the bus controller is elongated.

16. A digital communication method that comprises:
detecting periodic pulses on a shared signal conductor, each pulse initiating a data transmission slot; and
determining which of the data transmission slots correspond to a local node ID, said determining including:
driving the shared signal conductor with a pulse representing a resynchronization request if n-1 consecutive data transmission slots are empty, n being a total number of sensors connected to the shared signal conductor; and
upon driving or detecting a pulse representing a resynchronization request, tracking a data transmission slot count that treats a first data transmission slot after the resynchronization request as the first data transmission slot in a series of frames each having n data transmission slots, each data transmission slot in the frame having a slot count that matches a respective node ID.

17. The digital communication method of claim 16, wherein said determining further includes setting the data transmission slot count based on a node ID included in a data transmission from another sensor.

18. The digital communication method of claim 16, wherein each data transmission slot is sized to accommodate multiple bytes, and wherein the pulse representing a resynchronization request has a position corresponding to a second of the multiple bytes.

19. The digital communication method of claim 18, wherein each node is configured to treat a data transmission slot as empty if that data transmission slot lacks a first byte.

20. The digital communication method of claim 16, further comprising:
generating a local clock signal;
aligning the local clock signal with the periodic pulses; and
sending digital data during the data transmission slots corresponding to the local node ID.

21. The digital communication method of claim 16, wherein said determining includes resetting the data transmission slot count upon detecting that one of the period pulses is elongated.
